(19) United States
(12) Patent Application Publication
(10) Pub. No.: US 2011/0010990 A1
(43) Pub. Date: Jan. 20, 2011

(54) Device and Method for Rooting and/or Dormancy for Plant Bulbs

(76) Inventor: Darrell Harvey Richardson, Spirit Lake, ID (US)

Correspondence Address: WELLS ST. JOHN P.S., 601 W. FIRST AVENUE, SUITE 1300, SPOKANE, WA, 99201, US

(21) Appl. No.: 12/833,803

(22) Filed: Jul. 9, 2010

Related U.S. Application Data
(60) Provisional application No. 61/226,560, filed on Jul. 17, 2009.

(51) Int. Cl. A01G 9/02; H05B 3/10

(52) U.S. Cl. 47/65.7; 47/65.5; 47/66.6; 47/85; 47/66.7; 219/552

(57) ABSTRACT

The present disclosure provides devices for rooting and/or dormancy for plant bulbs. The devices can include at least two components configured to form a chamber when engaged and at least one of the components can receive electronic communication and control the environment within the chamber. The devices can include at least one tray, which supports one soil vessel within the chamber. The chamber is environmentally controlled to provide rooting and/or dormancy for plant bulbs and can include at least two elements that engage and define a space substantially free of ambient light. At least one of the elements can control the environment within the space. The present method provides for bulb rooting and/or dormancy by coupling at least two components to form a chamber and providing an environment conducive to bulb rooting and/or dormancy within the chamber by maintaining a predetermined temperature within the chamber.

### CROSS REFERENCE TO RELATED APPLICATION

This application claims priority to U.S. Provisional Patent Application Ser. No. 61/226,560 which was filed on Jul. 17, 2009, the entirety of which is incorporated by reference herein.

### TECHNICAL FIELD

The present disclosure provides a device and method for rooting and/or dormancy for plant bulbs using an environmentally controlled chamber.

### BACKGROUND

For thousands of years people have enjoyed the beauty of plants. However, many plants are biologically locked into a growth cycle which requires freezing and thawing. For example, many bulbs require a certain period of cold and warmer temperatures to be stimulated to grow, such as is experienced as the seasons change.

Unfortunately, those who enjoy plants have been limited in their enjoyment by these seasonal requirements. In the past, bulbs have been rooted to grow by simulating all or part of those seasonal changes. However, the techniques used to root bulbs have been bulky, expensive, labor intensive, or otherwise unsuitable.

### SUMMARY

Embodiments of the present disclosure provide devices for providing rooting and/or dormancy for plant bulbs. The devices can include at least two components, the components configured to form a chamber when operatively engaged. At least one of the components can be configured to receive electronic communication and operatively control the environment within the chamber. The devices can include at least one tray within the chamber, with the tray configured to support at least one soil vessel.

Embodiments of the present disclosure provide environmentally controlled chambers used for providing rooting and/or dormancy for plant bulbs. The chambers can include at least two elements that are configured to engage and define a space therein. The defined space can be substantially free of ambient light and at least one of the elements of the device can be configured to operatively control the environment within the space.

Embodiments of the present disclosure can provide bulb rooting and/or dormancy methods. Example implementations of the methods can include enclosing bulbs within a chamber by coupling at least two components and providing an environment conducive for bulb rooting and/or dormancy within the chamber. The chamber can be free of ambient light and a predetermined temperature can be maintained within the chamber.

### BRIEF DESCRIPTION OF THE DRAWINGS

Embodiments of the disclosure are described below with reference to the following accompanying drawings.

FIG. 1 is a cutaway view of an illustrative chamber according to an embodiment.

FIG. 2 is a cutaway view of an illustrative chamber with a tray according to an embodiment.

FIG. 3 is a cutaway view of an illustrative chamber with a stand according to an embodiment.

FIG. 4 is a cutaway view of an illustrative chamber with soil vessels according to an embodiment.

FIG. 5 is a cutaway view of an illustrative chamber showing a heating circuit and a removable power supply converter according to an embodiment.

FIG. 6 is a profile view of a stand with a heating circuit and a removable power supply converter according to an embodiment.

FIG. 7 is a cutaway view of a heating circuit according to an embodiment.

FIG. 8 is a profile view of a stand showing placement of a heating circuit according to an embodiment.

FIG. 9 is a cutaway view of an illustrative chamber with separator components according to an embodiment.

FIG. 10 is a cutaway view of an illustrative chamber with a switch according to an embodiment.

FIG. 11 is an illustrative method for rooting and/or providing dormancy for plant bulbs according to an embodiment.

FIG. 12 is an illustrative method for enclosing multiple plant bulbs with separator components according to an embodiment.

FIG. 13 is an illustrative method for inverting the chamber to cool the soil vessels according to an embodiment.

### DESCRIPTION

This disclosure is submitted in furtherance of the constitutional purposes of the U.S. Patent Laws “to promote the progress of science and useful arts” (Article 1, Section 8).

The present device and/or methods can provide the consumer with the ability to root, keep plant bulbs dormant, and/or germinate seeds. Other methods in use today are awkward or risky. For example, currently users have to bury the soil vessels in the ground and somehow dig them up when needed. Some users may buy a standard refrigerator, place it in the house and dedicate it to rooting plant bulbs. Users may dedicate a large section of the refrigerator that we all have at home to rooting the bulbs. This is typically the crisper drawer or one of the shelves. One of the drawbacks of this method is the gasses emitted by decaying fruit or vegetables will cause the bulbs to die. Another drawback is the space in the refrigerator and time needed (months). A user may have a cold frame outside; however the bulbs have to be covered so they are not receiving sun light, and use of the cold frame may be cumbersome.

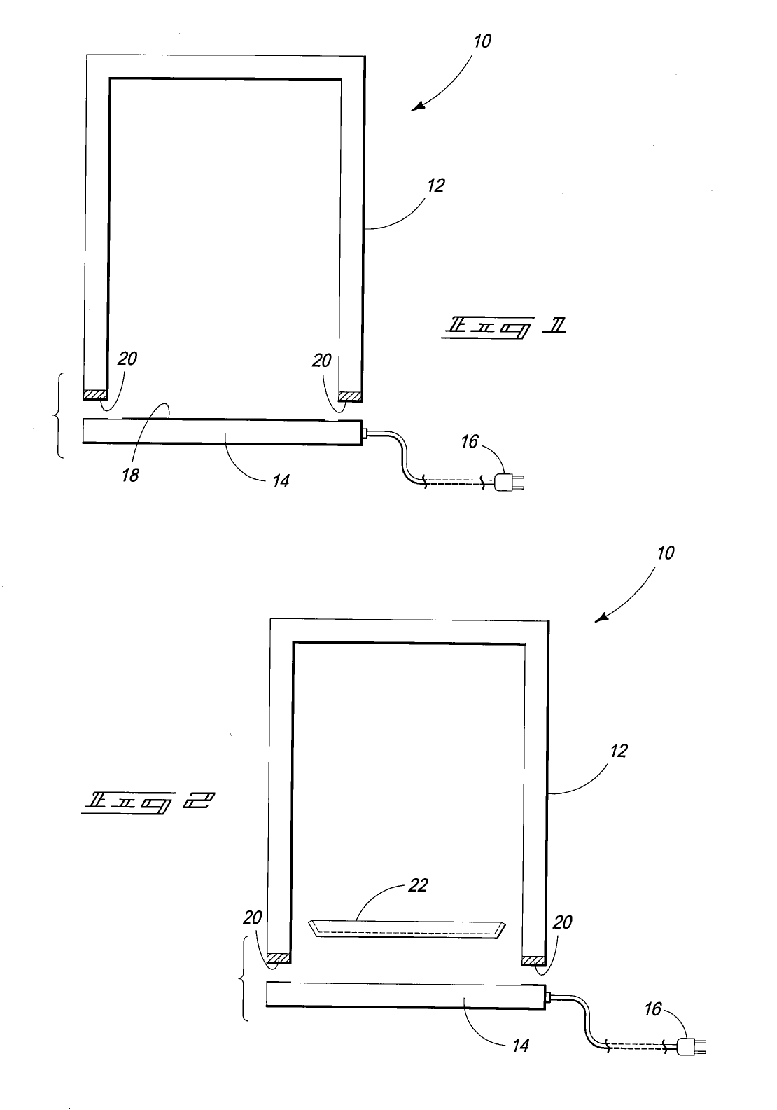

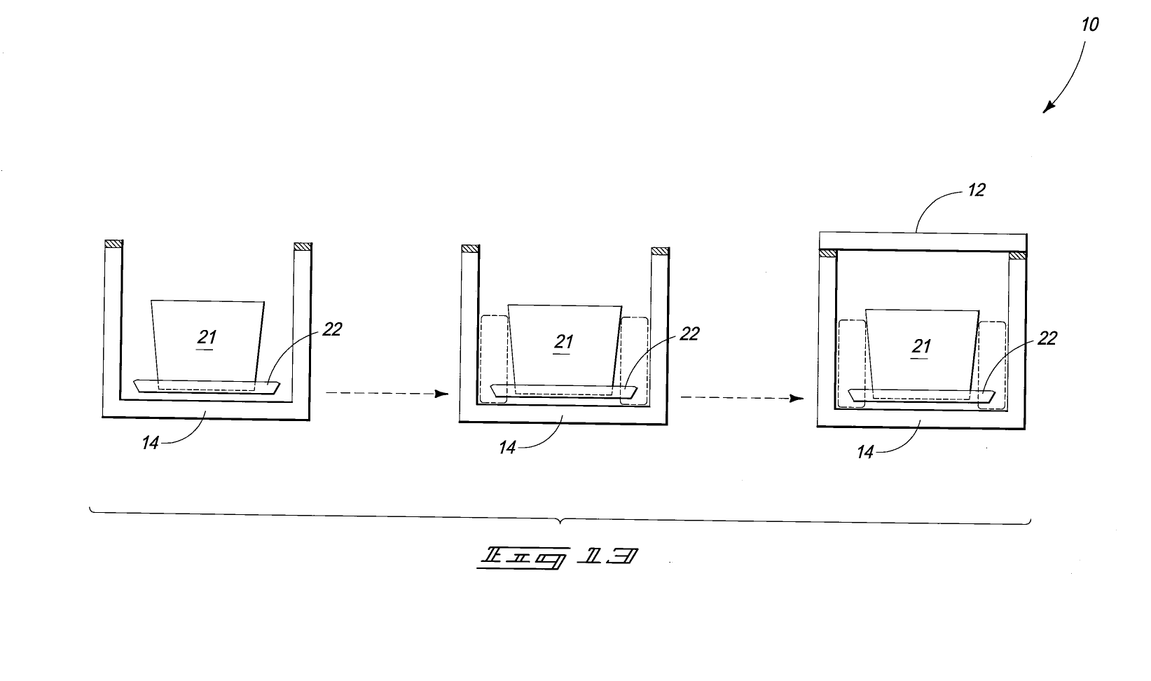

The devices and methods of the present disclosure are described with reference to FIGS. 1-13. Referring first to FIG. 1, device 10 is shown that can include components 12 and 14. Device 10 can be configured to provide rooting and/or dormancy for plant bulbs. In accordance with example embodiments, component 12 can be configured as an open box and component 14 can be configured as a complimentary lid that can seal component 12 to form a substantially rectangular chamber. Components 12 and/or 14 can be comprised of a fire retardant and/or insulative material. Either or both of components 12 and/or 14 can be configured to receive electronic communication.

According to example implementations, component 14 can be configured to receive electronic communication 16 to facilitate the control of the environment within the chamber. Either or both of components 12 and/or 14 can include a plateau. The plateau can provide a surface elevated from the open box/lid interface and allows objects within the chamber to be kept in a stagnant bubble of air. As an example, component 14 can include a plateau 18. Component 14 may define a trough or opening extending from the edge slightly into the raised section. The trough or opening may be utilized to pass a power cord from inside the chamber to outside, keeping below the edge of the chamber.

A strip of high density polymeric material 20 can be affixed between components 12 and 14 for example. In accordance with example implementations, material 20 can be affixed to the lip of the open box component that meets with the lid component. Material 20 can provide a poorly adhering surface to ice, which can facilitate the separating of the components 12 and 14, which, in specific implementations, can allow for the chamber to be opened during freezing temperatures.

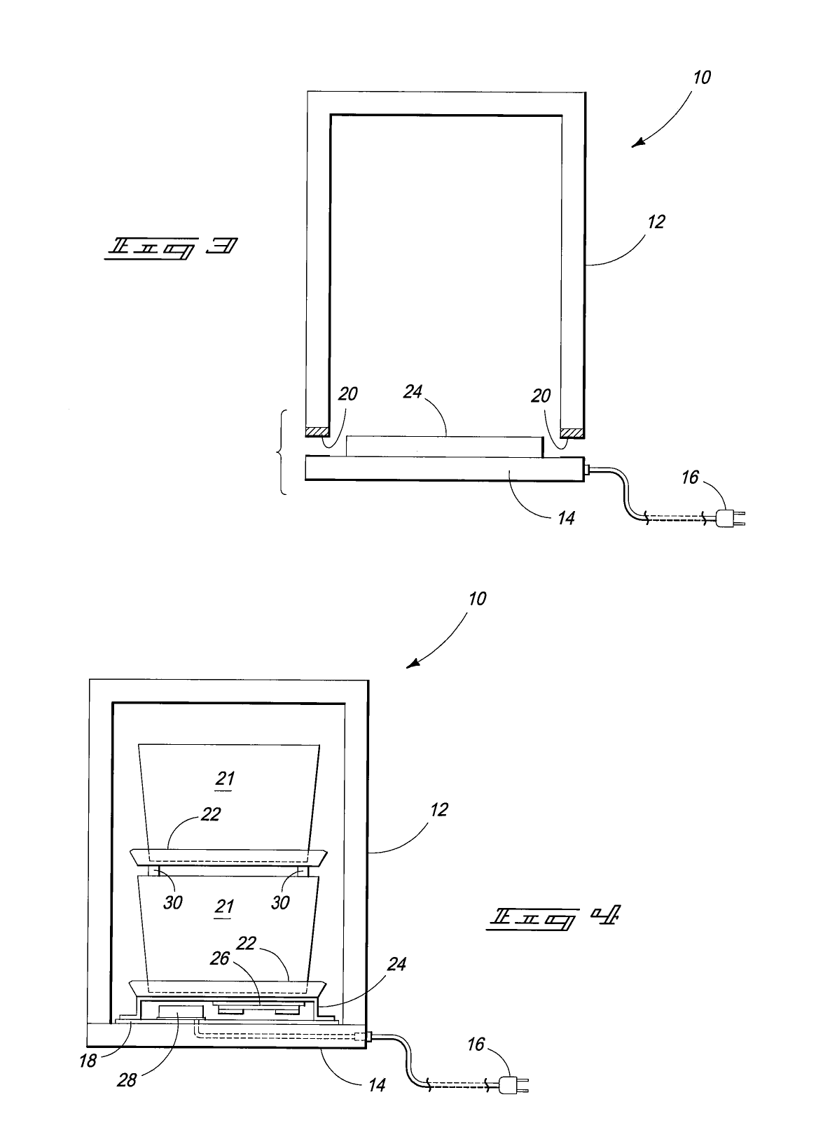

Referring next to FIG. 2, device 10 is shown that can include at least one tray 22 within the chamber, the tray being configured to support at least one soil vessel. Tray 22 can be manufactured from a wood, kilned, and/or polymeric material. Example wood materials can include mold resistant wood materials such as cedar; kilned materials can include pottery.

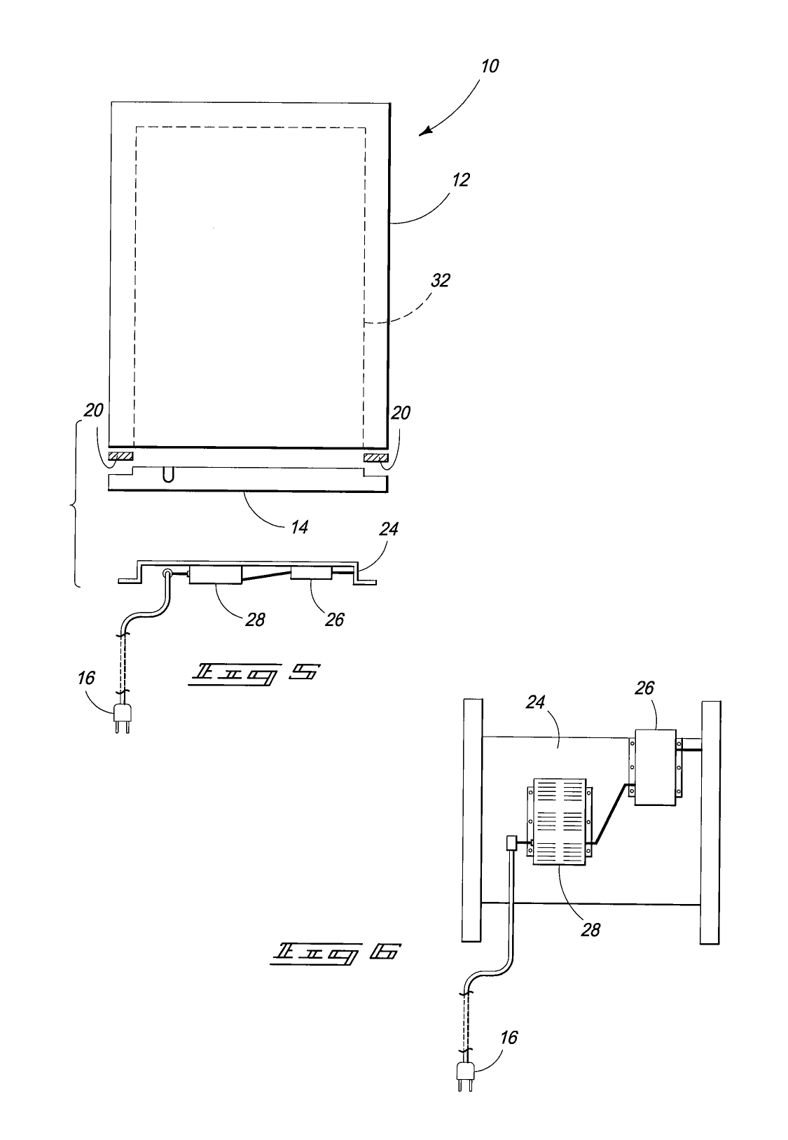

Referring next to FIG. 3, component 14 can receive an electronically dissipative stand 24. Stand 24 can be configured to compliment a tray for example to facilitate the placing of soil vessels thereon. Stand 24 can be configured to serve both as a pedestal for both a tray 22 and soil vessels, and as a housing for various electrical components that control the environment within the chamber.

Referring next to FIG. 4, device 10 is shown that can receive multiple trays 22 and soil vessels 21 upon stand 24. The underside of stand 24 can be configured to house a heating circuit 26 and a removable power supply converter 28, for example. Power supply converter 28 can be removed from the chamber when the temperature falls outside the range of the power supply converter's operating and storing limits. Power supply converter 28 can be configured to convert household electronic voltage to direct current.

In accordance with example implementations, the operational voltage and current may be kept low, for example at a maximum of 12V and/or 2A. This low voltage and low current can provide several advantages such as reduced energy use and increased user safety. Insulation and/or heat loss mechanisms are considered in construction of device 10 in order to utilize this low voltage and low current operation.

Referring again to FIG. 4, the multiple trays 22 and soil vessels 21 can be received by any interior side of the chamber and can be stacked upon each other. Separator components 30 can be received between the soil vessels 21 to promote air flow between the vessels. Separator components 30 can be composed of a substantially organic material, such as cedar. Organic materials, such as cedar wood, can provide a surface that is less conducive to molding within the potentially damp chamber during operation.

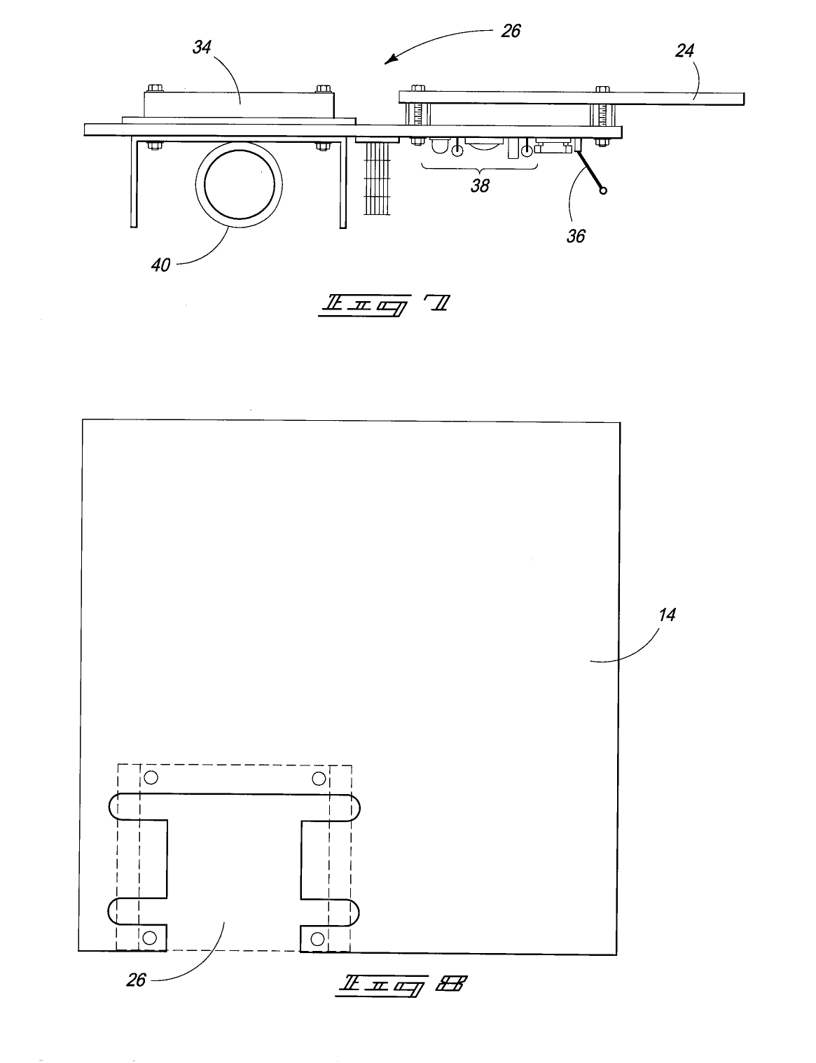

Referring next to FIG. 5, components 12 and 14 can be described as elements, which when operatively engaged define a space 32 within the chamber that is substantially free of ambient light. At least one of the elements is composed of a substantially opaque material, aiding in denying space 32 of ambient light. Space 32 can be defined by engaging components 12 and 14, and can be at least 0.01 m³, allowing for at least one tray and at least one soil vessel 21 within the space. In accordance with other example implementations, space 32 can be less than 1.0 m³.

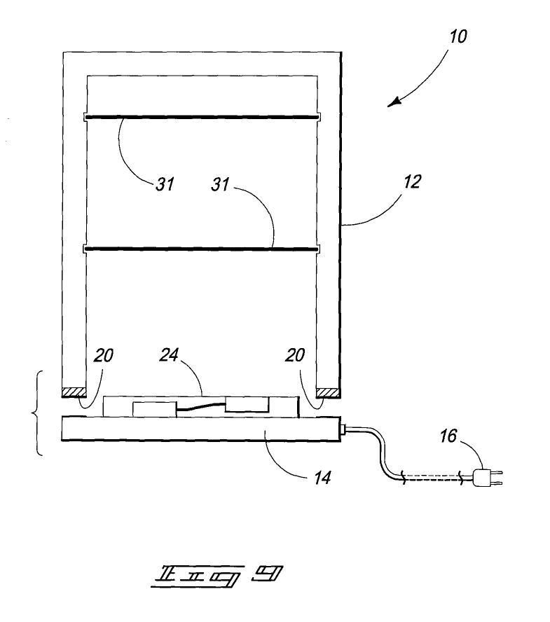

Referring next to FIG. 6, a profile view of the underside of stand 24 is shown. Power supply converter 28 can be offset from the center of the stand and provides support for same. Power supply converter 28 may be a polarized, grounded three conductor type. The chassis ground is routed to circuit board stand offs. This configuration can prevent electrostatic discharge (ESD) destruction. Heating circuit 26 can be attached to the edge of the underside of stand 24.

Referring next to FIG. 7, heating circuit 26 is shown as attached to stand 24. Heating circuit 26 can include a fan 34, a temperature sensor 36, and a temperature feedback mechanism 38. Fan 34 can be configured to facilitate the circulation of heat produced by a resistive heating element 40 throughout the chamber. Fan 34 can be oriented so that it rotates with the leading edges of the fan blades proximate element 40. In accordance with this implementation, fan 34 can be probed by small fingers without damage to the fan or the operator. Fan 34 can also provide a barrier above resistive heating element 40 to prevent the operator from contacting element 40 and perhaps incurring burn injuries (as the resister becomes hot during operation). A shield may also be provided between the operator and resistive heating element 40 to prevent the operator from being burnt. In other implementations, other shielding methods may be used. The circuit board is held off from the stand by stand-offs. Their purpose is to keep the circuit board from shorting to the stand.

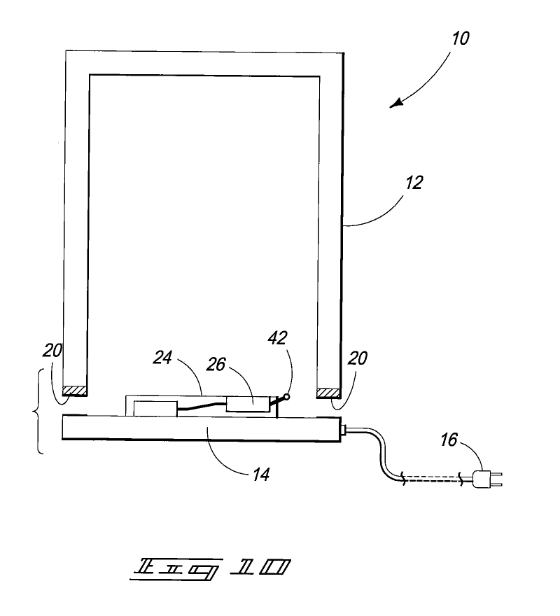

Element 40 may be preferred to a filament type light bulb, for example. Element 40 can minimize light within the chamber. Element 40 may be soldered to device 10. In the unlikely event of thermal runaway, the solder joint affixing element 40 will re-flow or melt allowing the resistive heating element to fall away, breaking the heating circuit electrical path, and reducing the chance of device destruction and/or fire. Referring next to FIG. 8, a profile view of component 14 is shown that includes the location of heating circuit 26. Several safety features may be incorporated. Electronics may be positioned on the inside of a fire retardant open box. Thus, if a fire were to start, it would rapidly be starved of oxygen, limiting combustion.

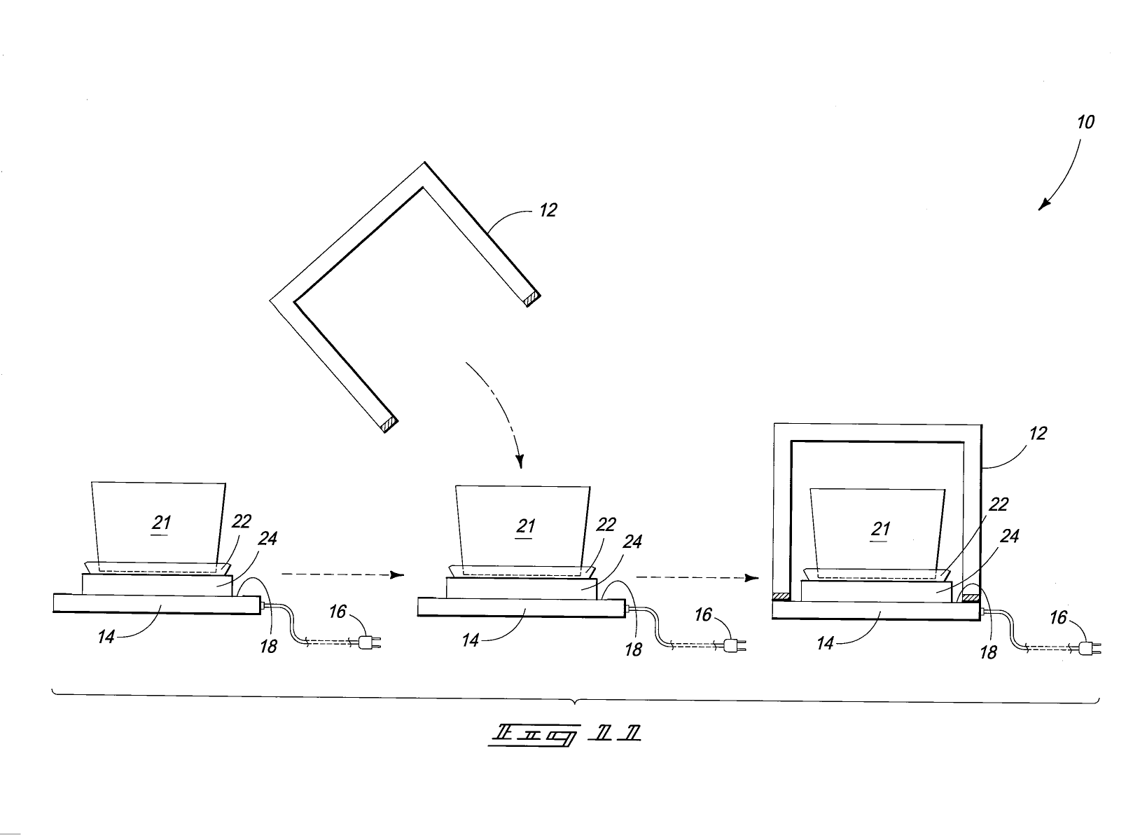

Referring next to FIG. 9, device 10 is shown having separator components 31 configured to be snapped into component 12. This configuration of separator components 31 may be utilized when device 10 is oriented so that component 12 becomes the base of the chamber and component 14 becomes the top of the chamber.

Referring next to FIG. 10, device 10 is shown that includes heating circuit 26, which is controlled by a controller that is configured as a switch 42 that may be toggled by the operator. Switch 42 can operatively control the heating circuit as well as allow the operator to toggle between preset temperature profiles. Switch 42 can be configured to select between preset dormant, rooting, and seed starting temperatures. In some implementations, the heating circuit may be controlled by a microcontroller or similar device, and allow various profiles of time and temperature to be used.

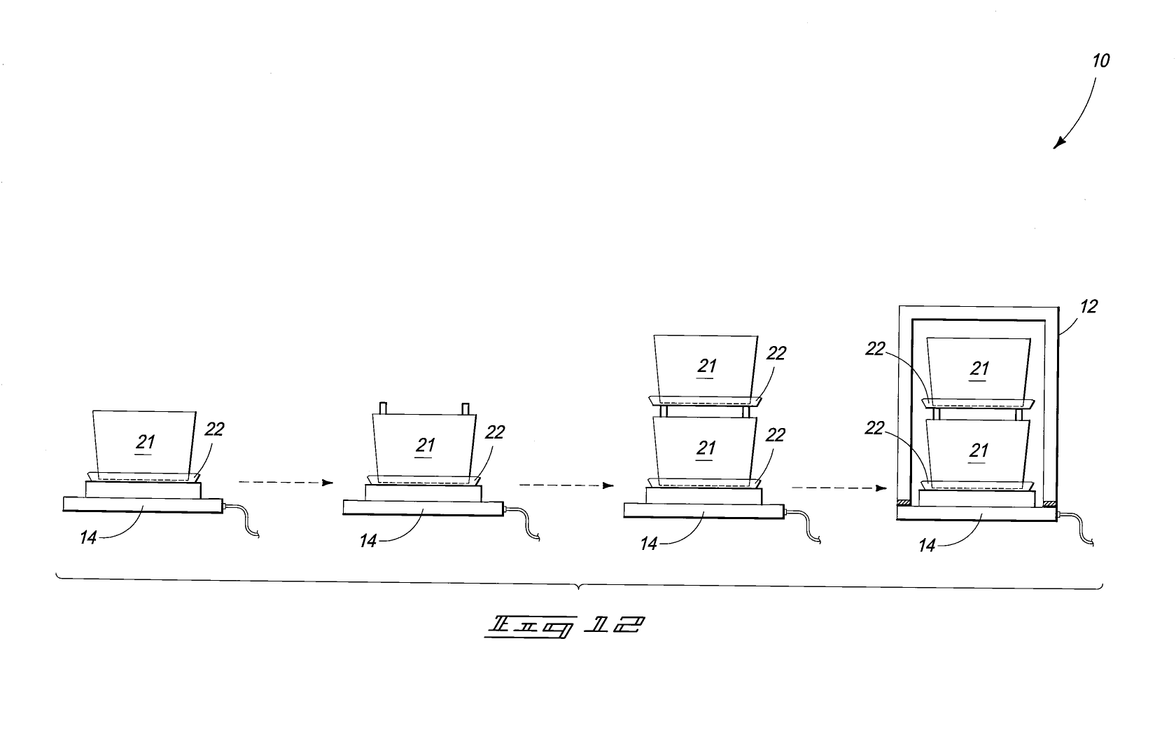

Referring next to FIGS. 11 and/or 12, methods for facilitating rooting and/or dormancy of plant bulbs are shown. Tray 22 and a soil vessel 21 can be placed upon stand 24, which rests on plateau 18 of component 14. Component 12 can be placed over the soil vessel 21 and may be releasably coupled to component 14, enclosing the plant bulbs within a chamber. The interior of the chamber can provide an environment conducive for bulb rooting and/or dormancy by denying ambient light to within the chamber and maintaining a predetermined temperature within the chamber. The interior environment can differ from the exterior environment when the device is in an operational configuration. Water condensation from the interior of the chamber may collect below plateau 18 and may run between the interface of components 12 and 14. While water may freeze to component 14 near its edges, high density polymeric material can prevent component 12 from freezing to ice on component 14. The method in FIG. 11 can be used to heat the interior of the chamber with a resistive heating element and to maintain a warmer environment than the exterior of the chamber. Device 10 can be used in an indoor environment, such as a garage, or placed outdoors and exposed to a more variable environment. The device may be configured to operate in temperatures as low as −40° C.

Referring next to FIG. 13, an alternate method for rooting and/or dormancy of plant bulbs is provided. When exterior temperatures are warmer than desirable for bulb rooting and/or dormancy, component 12 can be inverted from its general application and tray 22 and at least one soil vessel 21 may be placed within component 12. A removable cooling source can be placed around the soil vessel 21 and component 14 can be placed on top of component 12 to form a chamber. When configured in this manner, the chamber of the device can be colder than the exterior environment and conducive to bulb rooting and/or dormancy. The removable cooling source may be replaced periodically to maintain the desired temperature within the chamber.

An illustrative process of using the device is now discussed for illustration, and not by way of limitation.

1) When outside temperature lows are around 40° F. or lower and heading lower for winter:

2) Put bulbs in soil vessels with potting soil and water.

3) Plug in power supply.

4) Touch stand to discharge any static.

5) Put pot #1 in chamber on top of stand.

6) Place separator components on top of pot #1.

7) Place pot #2 on top of separator components.

8) Set temperature to rooting.

9) Put open box on lid and over soil vessels.

10) When bulbs have received their dormancy period, remove upper pot and place in lighted window.

11) Change chamber temperature to ‘dormant’ to stall out pot #2.

12) When pot #1 approaches the end of its blooming, remove pot #2 and place in window.

13) When temperature minimums are >0° C. for the season, unplug chamber.

The following options may be used:

1) To start earlier, hence have sprouted bulbs ready earlier:
a. Bring device 10 into a relatively controlled environment with highs no more than 26.6° C.
b. Remove stand from chamber.
c. Turn device 10 up-side-down. It will now resemble a standard box.
d. Place stand in bottom of chamber.
e. Place pot #1 in chamber, having loaded and watered it.
f. Place separator components on pot #1.
g. Place pot #2 on top of separator components.
h. Place ‘Blue Ice’ or equivalent on top of pot #2.
i. Place lid on top of open box.
J. Replace ice pack twice a day or as needed to keep pot temperatures between 0° C. and about 10° C.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

1. A device for providing rooting and/or dormancy for plant bulbs, the device comprising:
at least two components, the components configured to form a chamber when operatively engaged;
at least one of the components configured to receive electronic communication and operatively control the environment within the chamber; and
at least one tray within the chamber, the tray configured to support at least one soil vessel.

2. The device of claim 1 wherein the chamber is substantially rectangular.

3. The device of claim 2 wherein one of the two components defines an open box and the other of the two components defines a lid configured to seal the open box and form the chamber therein.

4. The device of claim 3 wherein a portion of the open box comprises a layer of high density polymeric material.

5. The device of claim 1 wherein at least a portion of at least one of the two components comprises a fire-retardant material.

6. The device of claim 1 wherein at least a portion of at least one of the two components comprises an insulative material.

7. The device of claim 1 wherein the component configured to receive electronic communication defines a stand.

8. The device of claim 7 wherein the underside of the stand comprises one or more of a heating circuit, a fan, a temperature sensor, and a temperature feedback mechanism.

9. The device of claim 8 wherein the heating circuit comprises a resistive heating element.

10. The device of claim 1 wherein the component configured to receive electronic communication defines a plateau, the plateau providing support for the stand and providing space between the stand and the open box/lid interface.

11. The device of claim 1 wherein the component configured to receive electronic communication is coupled to a removable power supply converter, the power supply converter converting household electronic voltage to direct current to operatively control the environment within the chamber.

12. The device of claim 1 wherein at least one of the trays is received by at least one interior side of the chamber.

13. The device of claim 1 further comprising separator components received between the soil vessels, the separator components comprising a substantially organic material such as, but not limited to, cedar.

14. An environmentally controlled chamber used for providing rooting and/or dormancy for plant bulbs, the chamber comprising:
at least two elements, the elements configured to engage and define a space therein, the defined space being substantially free of ambient light; and
at least one of the elements configured to operatively control the environment within the space.

15. The device of claim 14 wherein at least a portion of at least one of the elements is composed of a substantially opaque material.

16. The device of claim 14 wherein the space defined by engaging the elements is at least 0.01 m³.

17. The device of claim 14 wherein the element configured to operatively control the environment within the space is configured to receive electronic communication from a controller.

18. The device of claim 17 wherein the controller operatively controls the heating circuit.

19. The device of claim 18 wherein the controller includes a switch that may be toggled.

20. A bulb rooting and/or dormancy method comprising:
enclosing bulbs within a chamber provided by coupling at least two components; and
providing an environment conducive for bulb rooting and/or dormancy within the chamber, the providing comprising denying ambient light to within the chamber and maintaining a predetermined temperature within the chamber.

21. The method of claim 20 wherein the enclosing comprises releasably coupling the two components.

22. The method of claim 21 wherein operatively engaging the open box and lid creates an interior environment within the chamber, the interior environment differing from the environment outside the chamber.

23. The method of claim 22 wherein a portion of at least one of the two components comprising a layer of high density polymeric material prevents the open box from freezing to the lid.

24. The method of claim 20 wherein the temperature within the chamber is maintained by either heating the interior of the chamber with a resistive heating element or by cooling the interior of the chamber with a removable cooling source.

25. The method of claim 20 wherein the chamber can be situated in either a controlled environment or exposed to an ambient environment.
